(19) United States
(12) Patent Application Publication
(10) Pub. No.: US 2016/0005221 A1
(43) Pub. Date: Jan. 7, 2016

(54) PHOTOMETRIC OPTIMIZATION WITH T-SPLINES

(71) Applicant: QUALCOMM Incorporated, San Diego, CA (US)

(72) Inventors: Thomas Mörwald, Vienna (AT); Johann Prankl, Wieselburg (AT)

(21) Appl. No.: 14/791,159

(22) Filed: Jul. 2, 2015

Related U.S. Application Data
(60) Provisional application No. 62/020,714, filed on Jul. 3, 2014.

(51) Int. Cl. G06T 17/00; G06K 9/00; G06T 5/00; G06T 7/00; G06T 7/20; G06T 7/40; H04N 5/235

(52) U.S. Cl. CPC G06T 17/00; G06T 7/408; G06K 9/00234; H04N 5/2352; H04N 5/2351; G06T 7/0038; G06T 7/0046; G06T 7/2093; G06T 5/003; G06T 5/005; G06T 2207/10024; H04N 2101/00

(57) ABSTRACT

One example method is disclosed that includes the steps of capturing a plurality of images of a scene, wherein each of the plurality of images of the scene captures a different perspective of a portion of an object; establishing a three-dimensional (“3D”) model of the object using at least some of the plurality of images of the scene; initializing a T-spline based at least in part on the 3D model; determining a first photometric error associated with the 3D model and the T-spline; and optimizing the T-spline based on the first photometric error to create an optimized T-spline.

### CROSS-REFERENCE TO RELATED APPLICATIONS

This application claims the benefit of U.S. Provisional Application No. 62/020,714, filed Jul. 3, 2014, entitled “Photometric Optimization with T-Splines” the entirety of which is incorporated herein by reference.

### BACKGROUND

Computer vision and object recognition involve the use of camera images to capture and recognize three-dimensional shapes and associated objects from multiple camera images. Various sensors that are part of devices such as digital cameras, phones with embedded cameras, or other camera or sensor devices may be used to create and store images of a scene, and objects may be recognized from these images. Certain methods of computer vision calculate three-dimensional positions of points on the surface of an object by triangulating matching points between images where the relative position of the camera at the time each image was taken is known. In many circumstances, there are numerous factors that limit and degrade the quality of captured images, such as atmospheric blurring, motion effects, camera blurring effects, and sampling effects. Because of this, basic triangulation may provide a coarse surface model.

To achieve higher accuracy, additional optimization may be used. Common approaches for such optimization can be divided into two groups. The first is based on triangular meshes. In such optimization, a planar patch tangential to the surface is assigned to each vertex. Then the position is optimized by minimizing the reprojection error (i.e., maximizing the photo-consistency) of image bundles. Typically a C1-continuous regularization term provides explicit dependency of the variation of neighboring vertices. Another approach is to exhaustively search the solution space and find a global minimum using either deformable models, level-sets or graph-cuts.

### BRIEF SUMMARY

Various examples are described for photometric optimization with T-splines. One example method comprises capturing, using a camera module of a device, a plurality of images of a scene, wherein each of the plurality of images of the scene captures a different perspective of a portion of an object; establishing a three-dimensional (“3D”) model of the object using at least some of the plurality of images of the scene; initializing a T-spline based at least in part on the point cloud; determining a first photometric error associated with the 3D model and the T-spline; and optimizing the T-spline based on the first photometric error to create an optimized T-spline.

One example system for optimizing T-splines using photometric error includes a non-transitory computer-readable medium; and a processor in communication with the non-transitory computer-readable medium and configured to execute program code stored in the non-transitory computer-readable medium, the processor configured by the program code to: capture a plurality of images of a scene, wherein each of the plurality of images of the scene captures a different perspective of a portion of an object; establish a three-dimensional (“3D”) model of the object using at least some of the plurality of images of the scene; initialize a T-spline based at least in part on the 3D model; determine a first photometric error associated with the 3D model and the T-spline; and optimize the T-spline based on the first photometric error to create an optimized T-spline.

In another example, a non-transitory computer readable medium comprises program code for causing a processor to execute a method for using T-splines for photometric optimization, the program code comprising: program code for capturing a plurality of images of a scene, wherein each of the plurality of images of the scene captures a different perspective of a portion of an object; program code for establishing a three-dimensional (“3D”) model of the object using at least some of the plurality of images of the scene; program code for initializing a T-spline based at least in part on the 3D model; program code for determining a first photometric error associated with the 3D model and the T-spline; and program code for optimizing the T-spline based on the first photometric error to create an optimized T-spline.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1A-1B illustrates aspects of a system that may be used to implement photometric optimization with T-splines according to certain implementations;

FIG. 2 illustrates a flowchart for an example method of implementing photometric optimization with T-splines;

FIGS. 3A-4H illustrate example iterative optimizations of T-splines;

FIG. 5 is one implementation of a computing device which may be used in certain T-spline photometric optimization systems and devices; and

FIG. 6 is one implementation of a network system which may be used in certain T-spline photometric optimization systems.

### DETAILED DESCRIPTION

Examples are described herein in the context of photometric optimization with T-splines. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

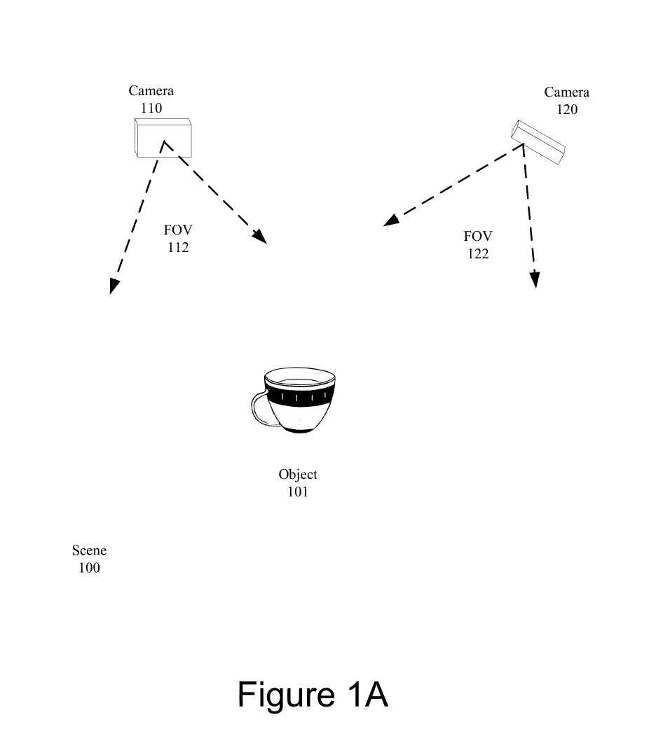

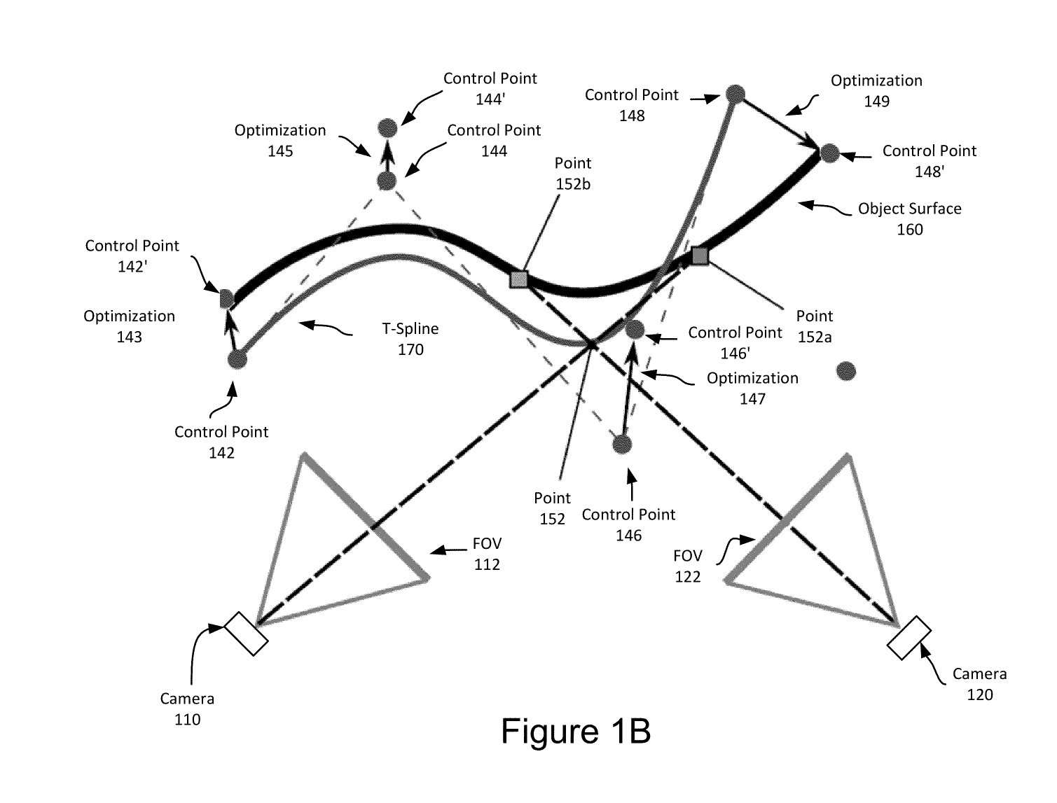

In one illustrative example method, a digital camera captures at least two images from different perspectives of a three-dimensional object. Referring now to FIG. 1A, FIG. 1A shows a scene 100 having an object 101. A camera takes two images of the object 101 from two different viewpoints 110, 120. Because the viewpoints are different, the camera will have a different field of view (“FOV”) 112, 122 into the scene 100, and thus will capture different aspects of the object 101.

Referring now to FIG. 1B, FIG. 1B shows an example diagram of photometric optimization with T-splines. The diagram shows aspects of the scene 100 and includes two different perspectives having different fields of view 110, 120. FIG. 1B also shows a portion of the object 101, referred to in this discussion as the object surface 160. In this example, the camera may be any device capable of capturing images of a scene that may include one or more objects. In certain examples, two cameras may be setup at different locations to provide different viewpoints 110, 120 rather than moving the same camera to different positions. In still further examples, the system may be structured with a single stationary camera and may instead move object surface 160 to provide different perspectives on the object surface 160 to the stationary camera. In this example, two images are captured, with each image including a representation of object surface 160 from a different perspective.

From these two captured images, a computing device establishes an initial three-dimensional (“3D”) representation of the object, in this case, the 3D representation is a point cloud in a virtual three-dimensional space. To establish the point cloud, the computing device identifies reference points on the object that are visible within both of the images. In this example, the point cloud includes a representation of the object surface 160 shown in FIG. 1B.

Using this initial point cloud, the computing device generates an initial T-spline having an initial set of control points. A T-spline is a mathematical model for representing a curve or a surface that is represented by one or more control points. The relative position of the control points, as well as parameters associated with the control points, affects the curvature of the curve or surface defined by T-spline. Thus, the shape of a curve or surface may be adjusted by repositioning one or more control points. In this example, the point cloud represents a coarse approximate surface of the object in the images. An initial T-spline is constructed to generate a surface that roughly corresponds to at least a part of the coarse approximate surface provided by the point cloud. By adjusting the control points as described below, the surface defined by the T-spline can be adjusted to closely approximate the surface of the object in the images.

For example, the initial T-spline 170 is shown in FIG. 1B, which has four control points 142, 144, 146, 148. As can be seen, when the T-spline is initially generated, its control points 142-148 are located such that the points on the T-spline do not correspond well with points on the object surface 160, but instead merely provide a rough approximation of the object surface 160. The difference between the points on the T-spline, e.g. 152, and the points 152a, 152b on the object surface 160 is referred to as the photometric error. This may be caused, at least in part, by the different information from different perspectives for the images that are used to create the model.

The computing device traverses the curves defined by the initial T-spline 170 and selects one or more points on the T-spline for analysis. The computing device then projects one or more of the selected points on the T-spline 170 onto each of the images to identify pixels within the images that correspond to the points on the curves. The computing device then determines a photometric error based on differences in colors or intensities of the pixels from the different images at each projected point on the T-spline. For example, the computing device may project a point on the T-spline onto the two different images and identify the corresponding pixels. As can be seen in FIG. 1B, point 152 on T-spline 170 has a non-zero photometric error based on the distance between T-spline 170 and object surface 160 beneath point 152. Because of this difference and the different viewpoints, a ray projected from a hypothetical camera from viewpoint 110 that passes through point 152 intersects the object surface 160 at a different point 152a than a ray projected from a second hypothetical camera from viewpoint 120 that passes through point 152 and intersects the object surface at point 152b. If a point on the T-spline 170 has no photometric error, rays projected from the two viewpoints 110, 120 towards the point on the T-spline will intersect the object surface 160 at the same location.

In this example, point 152 may be considered a “reprojection point.” Given an image point (pixel) in a camera, a view ray may be traced from the camera to the T-spline model surface. This process is called reprojection since the point from the true surface that was formerly projected into the image plane is now reprojected onto the three-dimensional object model surface. The same reprojection can be performed for each image taken by a camera from different perspectives of the object or scene being captured, defining the correspondence of the pixels in different images of a plurality of images of a scene or object.

To determine the photometric error in this example, the computing device selects points on the T-spline and determines the colors of the points in the images that correspond the selected points, e.g., points 152a, 152b correspond to point 152 as projected onto the object surface 160 in this example. The differences between the colors for each point on the T-spline are used to determine a photometric error. Photometric error for different points from the T-spline are then used to generate a photometric error function.

The photometric error function is then compared against one or more thresholds to determine whether sufficient error exists such that optimization of the T-spline should be performed. If there is sufficient error, the photometric error function is used to adjust the position of one or more of the control points in the set of control points. For example, the optimization as shown with optimizations 143, 145, 147, and 149 is a change in the control points 142, 144, 146, 148 to move them to new positions 142′, 144′, 146′, 148′. In certain implementations of optimization, control points may be inserted when the error at a certain region of the T-spline surface does not grow smaller, or lies above a certain threshold after convergence of the optimization algorithm. In other implementations, control points may be removed if they are redundant with respect to the T-spline surface (e.g., the same surface can be represented without certain control points). In other embodiments, control points may be both removed and inserted.

The photometric error function is then recalculated and compared against the one or more thresholds. The method then iterates until the photometric error function satisfies the one or more thresholds, and the resulting T-spline is output.

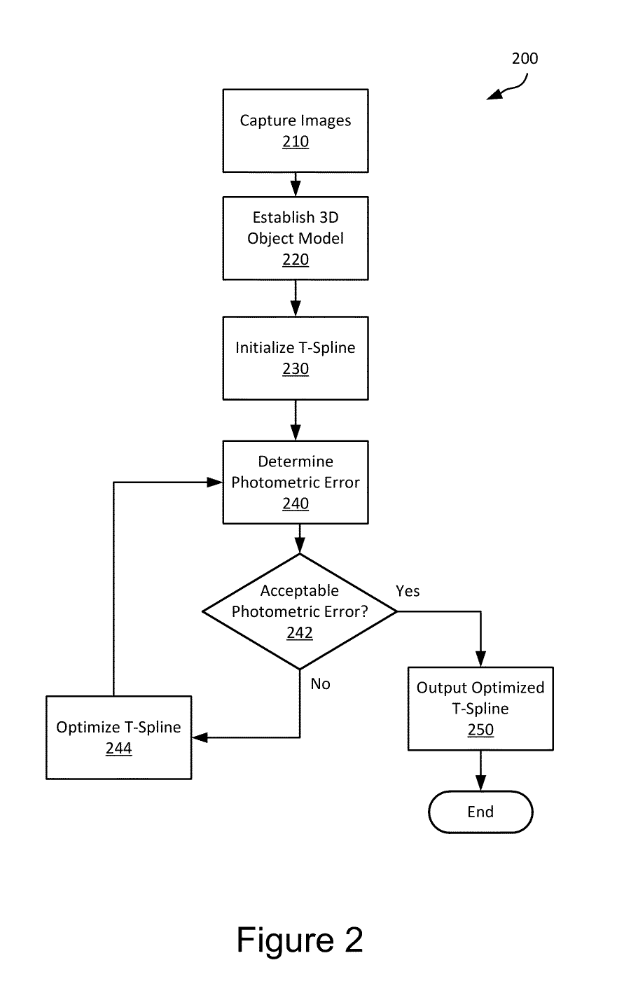

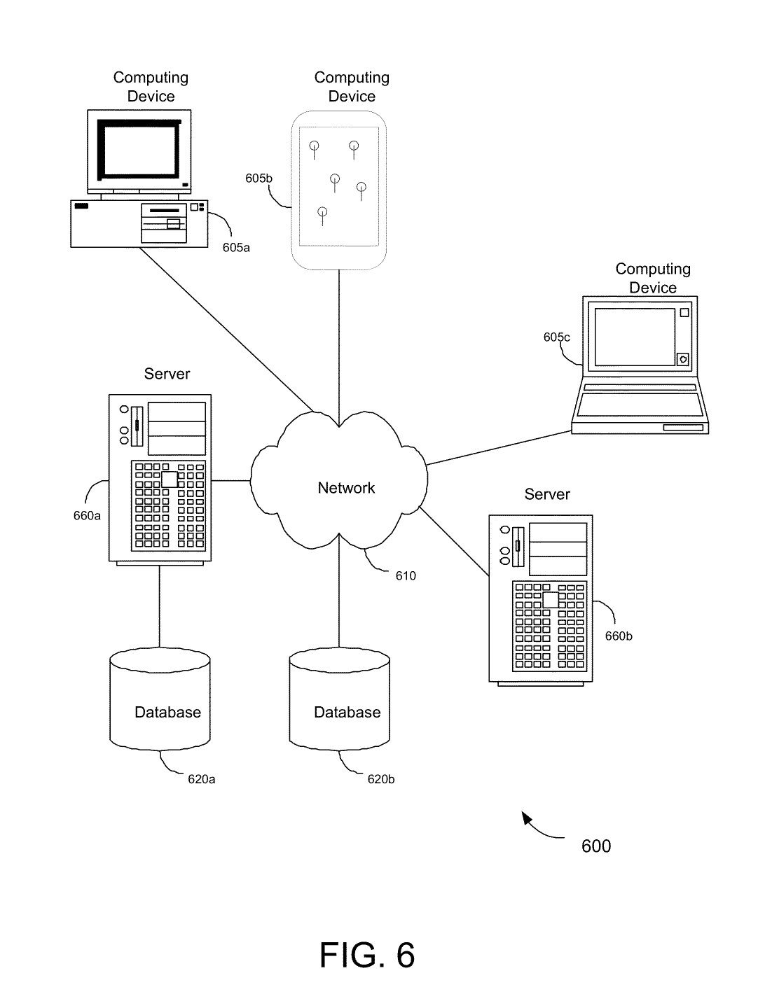

Referring now to FIG. 2, FIG. 2 shows an example method 200 for photometric optimization with T-splines. The method 200 of FIG. 2 may be performed by any suitable computing device or within an suitable computing environment, such as those discussed below with respect to FIGS. 6-7.

The method 200 of FIG. 2 begins in block 210 when a plurality of images of an object are captured. In this example, the computing device, such as computing device 510, employs its camera, or other suitable means for capturing keyframes, to capture images of the object from multiple different perspective points. Referring again to FIG. 1B, the scene includes an object 101 with a surface 160 and illustrates cameras 110, 120 capturing two different images of the object surface 160 from different viewpoints based on their respective fields of view 112, 122. In this example, the rather than using two cameras, a single camera takes two different images from the two different perspective points at locations 110, 120 in FIG. 1B. Though, in some examples, multiple cameras may be arrayed to capture images of an object surface 160 and communicate the images over a network, or via removable computer-readable media, to a computing device. For example, one means for capturing keyframes may comprise a database query or a command to copy or receive one or more image files from a local or remote file system.

In some cases, the computing device 510 may capture more than two images of the object surface 160. For example, the computing device 510 may be configured to capture video and may record video of the object as the computing device is moved to different locations. In such a case, if the computing device 510 captures 30 frames of video per second and records 5 seconds of video of the object surface 160, the computing device 510 will capture approximately 150 images of the object surface 160.

In some examples, the computing device 510 itself may not have a camera, but may instead receive images from another device or may obtain images from a computer-readable medium, such as a hard drive or a flash memory device. In these examples, the computing device 510 captures the images when it receives them from the other device or when it reads them from the computer-readable medium. For example, some suitable means for capturing keyframes include network interfaces and electrical interconnections between the network interfaces and a processor of the computing device. Some other suitable means for capturing keyframes include circuitry for accessing images stored on a computer-readable media, such as a hard disk or a flash drive, or in a database.

After the computing device 510 has captured images of the object surface, the method 200 proceeds to block 220.

At block 220, the computing device establishes a 3D model of the object using at least some of the images of the object surface 160.

In this example, the computing device 510 identifies distinctive reference points on the object that are visible in multiple images, such as based on local photometric descriptors and nearest-neighbor search, followed by a rejection of matches that are inconsistent with the epipolar geometry. In this example, the set of correspondences is then triangulated into a 3D point cloud, such as using a patch-based algorithm described in “Accurate, Dense, and Robust Multi-View Stereopsis” by Yasutaka Furukawa and Jean Ponce, published in the IEEE Transactions on Pattern Analysis and Machine Intelligence, 32(8):1362-1376 (2010).

After the point cloud has been established, the computing device 510 establishes a coarse model of the surface of the object based on the point cloud. In this example, a Poisson surface reconstruction algorithm as described in “Poisson Surface Reconstruction” by Michael Kazhdan, Matthew Bolitho, and Hugues Hopp, published in Eurographics Symposium on Geometry Processing (2006). This Poisson reconstruction may generate a coarse initial mesh representation of the object. In some examples, these algorithms may be parts of a means for establishing a 3D model of the object using at least some of the plurality of images of the scene. A means for establishing a 3D model of the object using at least some of the plurality of images of the scene may employ the foregoing algorithms.

Alternatives to the aforementioned approaches include algorithms that combine these steps into a convex optimization problem, such as described in “Continuous Global Optimization in Multiview 3D Reconstruction” by Kalin Kolev et al, published in the International Journal of Computer Vision, 84(1):80-96 (2009), or “Probabilistic Labeling Cost for High-Accuracy Multi-View Reconstruction” by Ilya Kostrikov, Esther Horbert, and Bastian Leibe, published in IEEE Conference on Computer Vision and Pattern Recognition, 1(1): 1534-1541 (2014).

In some examples, the computing device 510 may use other algorithms to establish a 3D representation of the object. For example, the computing device 510 may generate a visual hull to establish a 3D representation of the object. One suitable means for generating a visual hull is described in “The Visual Hull Concept for Silhouette-Based Image Understanding” by Aldo Laurentini, published in the IEEE Transactions on Pattern Analysis and Machine Intelligence, Vol. 16, No. 2, (February 1994).

These additional means for establishing a 3D model of the object using at least some of the plurality of images of the scene may be employed by computing devices 110 according to various examples of systems for photometric optimization with T-splines.

After the 3D representation of the object has been established, the method proceeds to block 230.

At block 230, the computing device 510 initializes a T-spline. In this example, the computing device uses planar parameterization to map every vertex of the coarse model of the surface (e.g., a mesh) to a rectangular domain. A suitable algorithm for planar parameterization is described in “Planar Parameterization of Triangulated Surface Meshes” by Laurent Saboret, Pierre Alliez, and Bruno Levy, published in the CGAL User and Reference Manual, v. 4.5 (available at http://doc.cgal.org/latest/Surface_meshparameterization/index.html) (also available at https://web.archive.org/web/20140817011910/http://doc.cgal.org/latest/Surface_mesh_p arameterization/index.html).

In addition, the computing device 510 also splits meshes of higher genus into rectangular patches. For example, the computing device 510 in this example employs the algorithm described in “Manifold T-Spline” by Ying He et al, published in the Proceedings of Geometric Modeling and Processing (2006). Further, in this example, the computing device fits a coarse T-spline having a low uniform resolution, e.g., 8×8, by minimizing the sum over the squared distances between the mesh vertices {vᵢ} and the T-spline surface with respect to the control points {vᵢ}:

$${argmin}_{\{ {b}_{j} \}} {\sum }_{i = 1}^{m} \frac{1}{2} ∥ {v}_{i} - S ( {ξ}_{i} , {θ}_{i} , {b}_{j} ) {∥}^{2}$$

In this example, (ξ, θ) is a point in the rectangular parameter domain, Ξ [symbol] Θ ⊂ [symbol] ². Here, Ξ and Θ are two real intervals, and [symbol] denotes the usual tensor product.

Further, a point on a general parametric surface S⊂ [symbol] ³ has the form:

$$x ( ξ , θ ) = {\sum }_{j = 1}^{n} {b}_{j} {ϕ}_{j} ( ξ , θ )$$

where bⱼε [symbol] ³ are the control points of the T-spline.

After the computing device has initialized the T-spline, the method 200 proceeds to block 240.

In this example, at block 240, the computing device 510 begins a processing loop to iteratively optimize the T-spline At block 240, the computing device determines a photometric error associated with the 3D model and the T-spline. Referring again to FIG. 1, as described above, point 152 on T-spline 170 has a non-zero photometric error as can be seen based on the distance between T-spline 170 and object surface 160 beneath point 152.

To determine a photometric error in this example, the computing device 510 selects a point on the T-spline and projects it onto the object surface 160 based on images taken from different viewpoints, referred to as “reprojection.” The difference between these points as reprojected for different images taken from different perspectives defines the measure of the photometric error. In this example, the photometric error may be considered based on the difference of the intensity (or color) values of the respective pixels in the images corresponding to the same point on the T-spline. For example, as may be seen in FIG. 1B, points 152a, 152b on the object surface may have different colors or intensities. The intensity values of these points 152a, 152b may be used, such as by determining the different between the intensity values, to generate an error value. After the T-spline is iteratively refined, the point 152 may approach the object surface 160, and may ultimately lie exactly on the object surface 160, at which time, the photometric error for point 152 becomes 0.

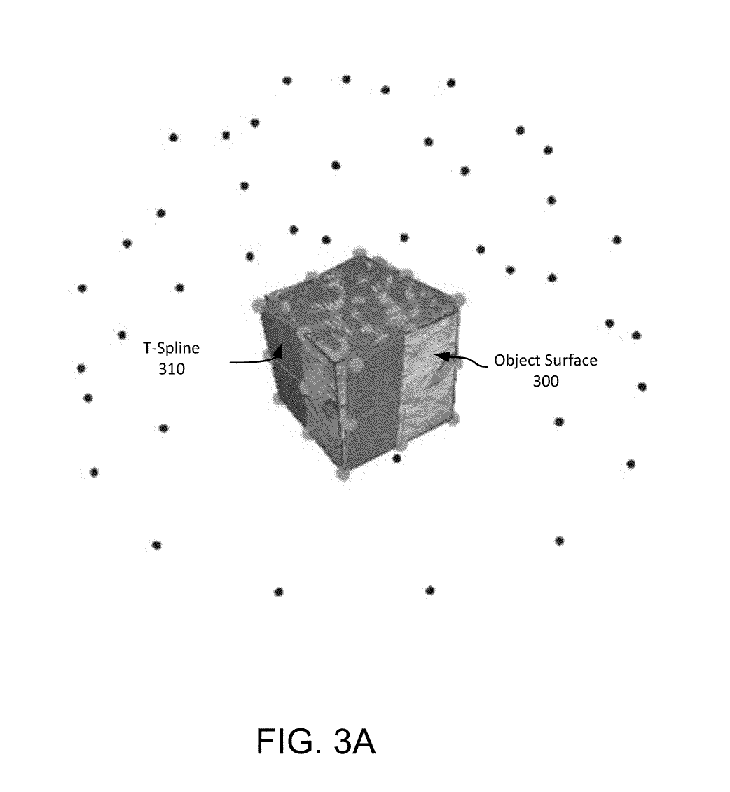

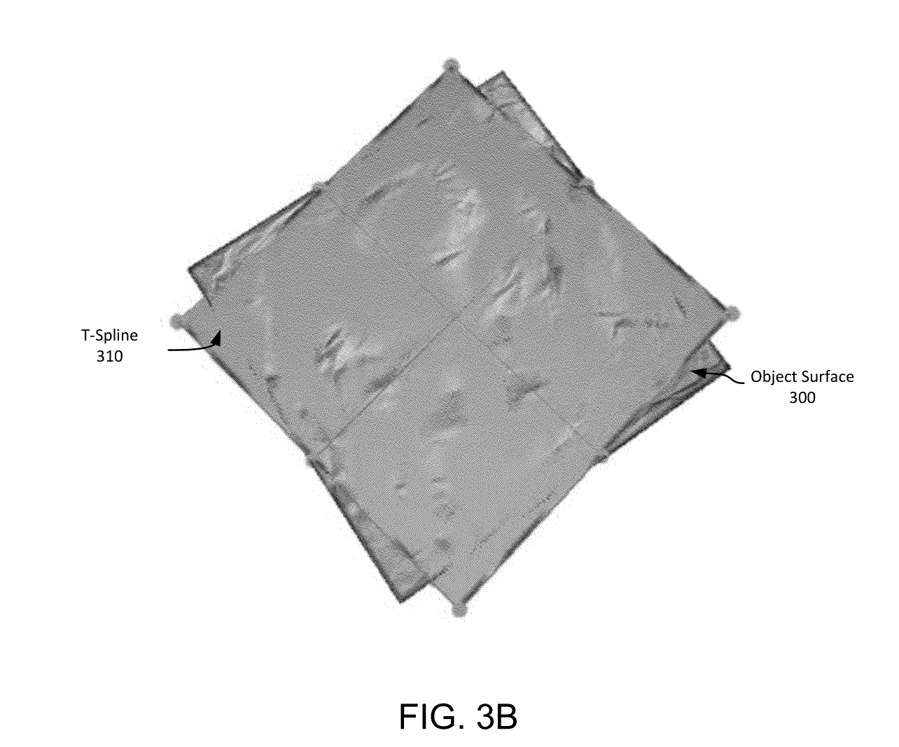

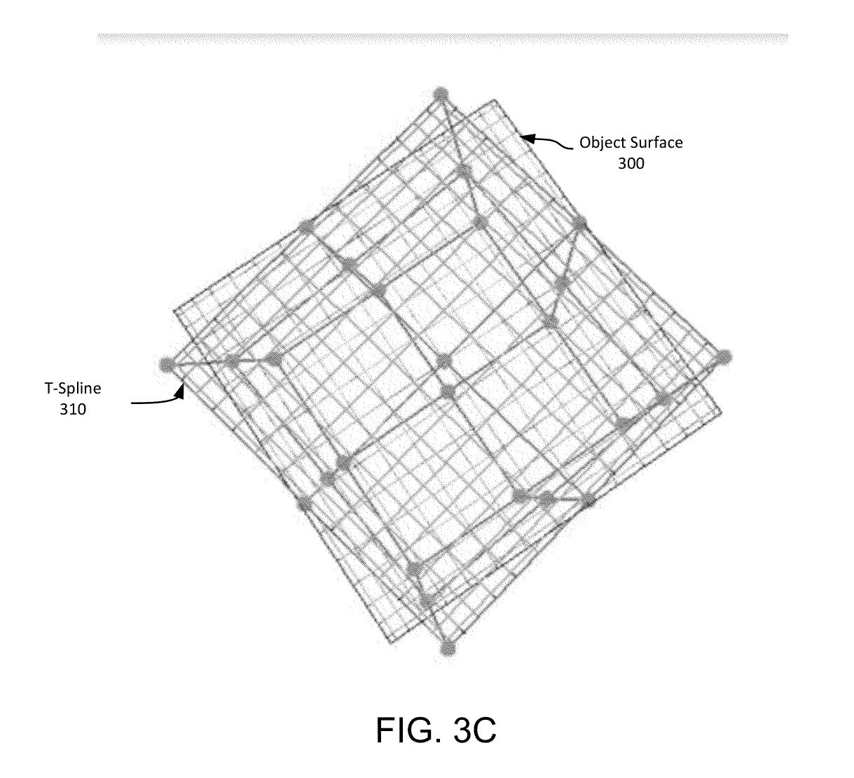

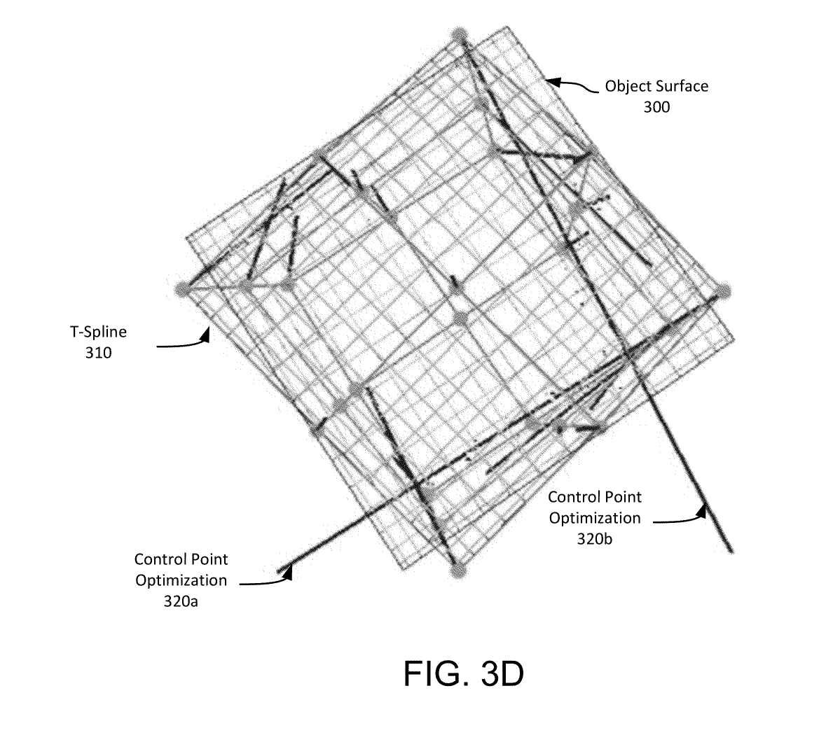

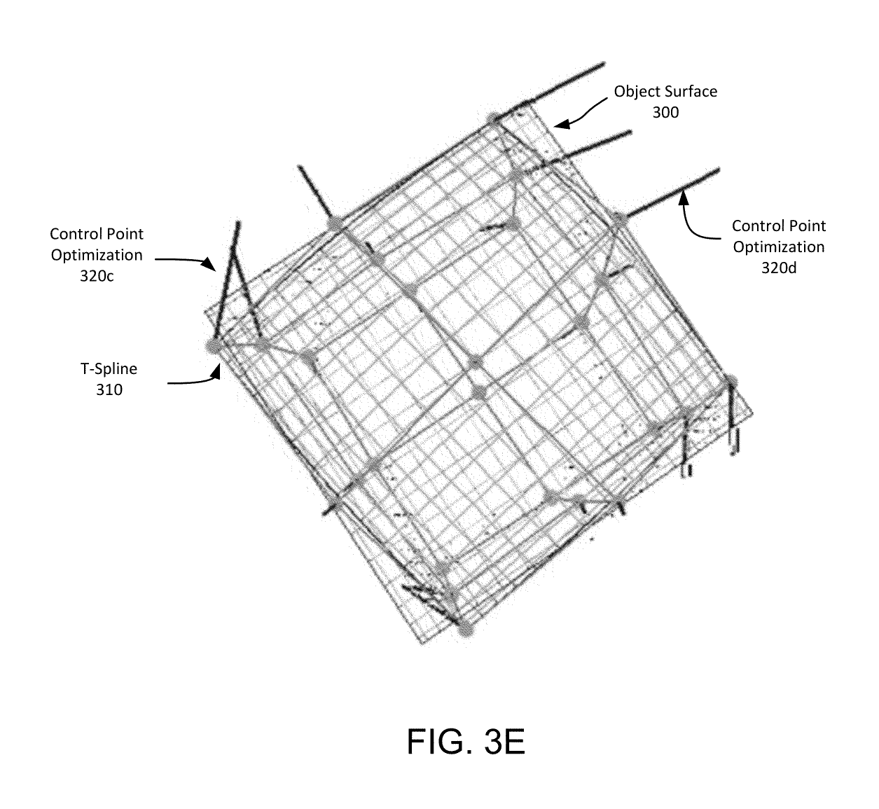

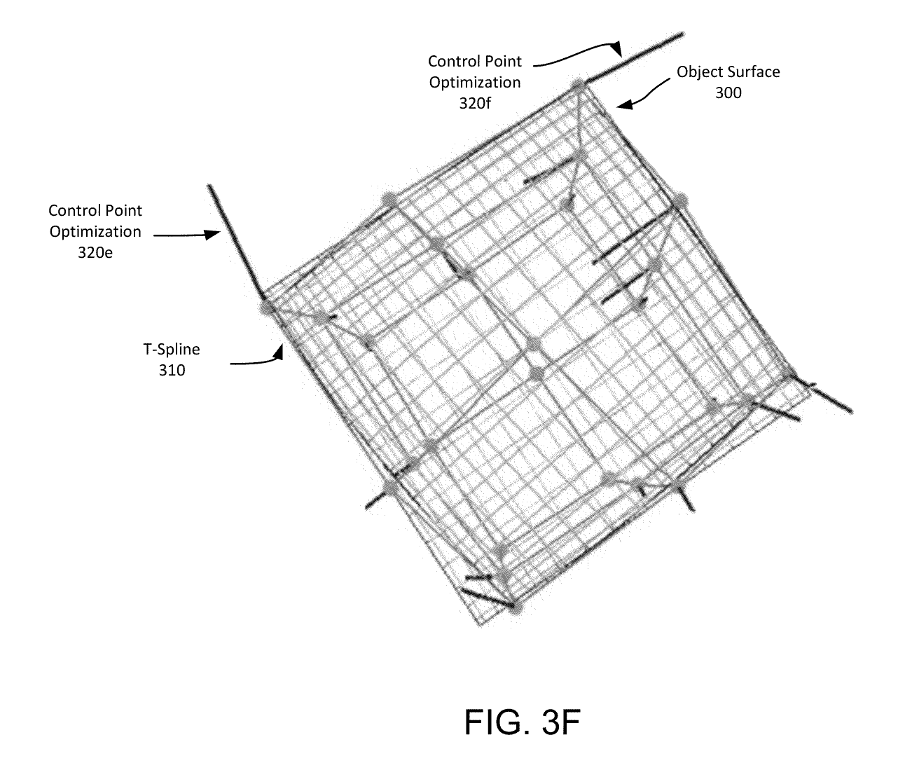

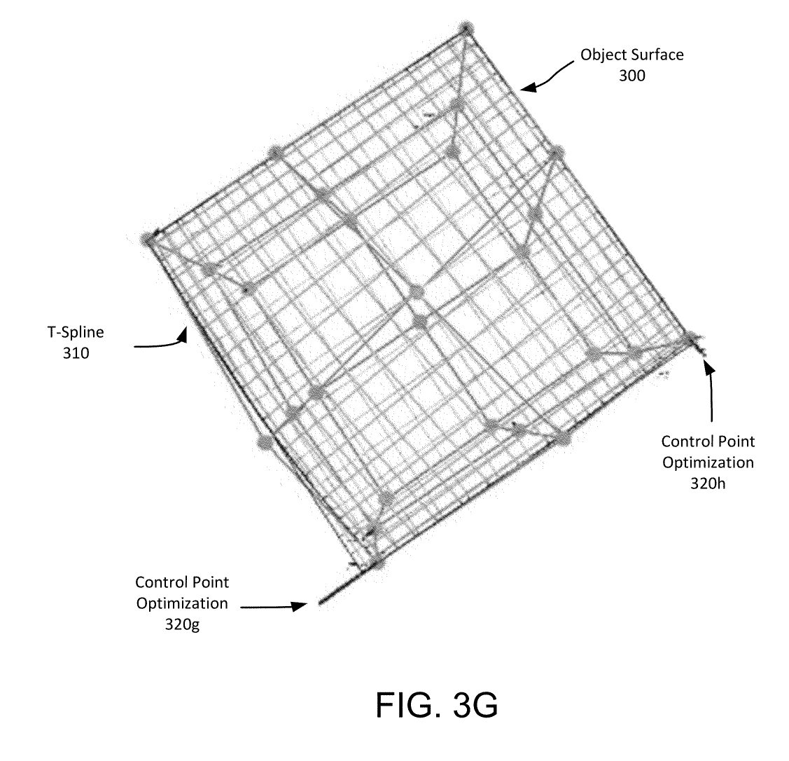

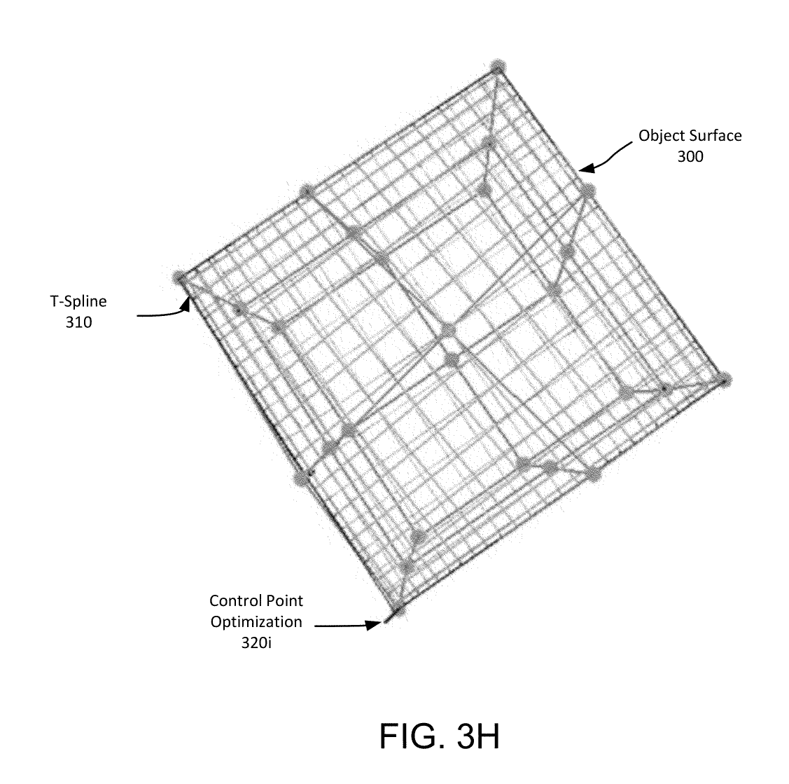

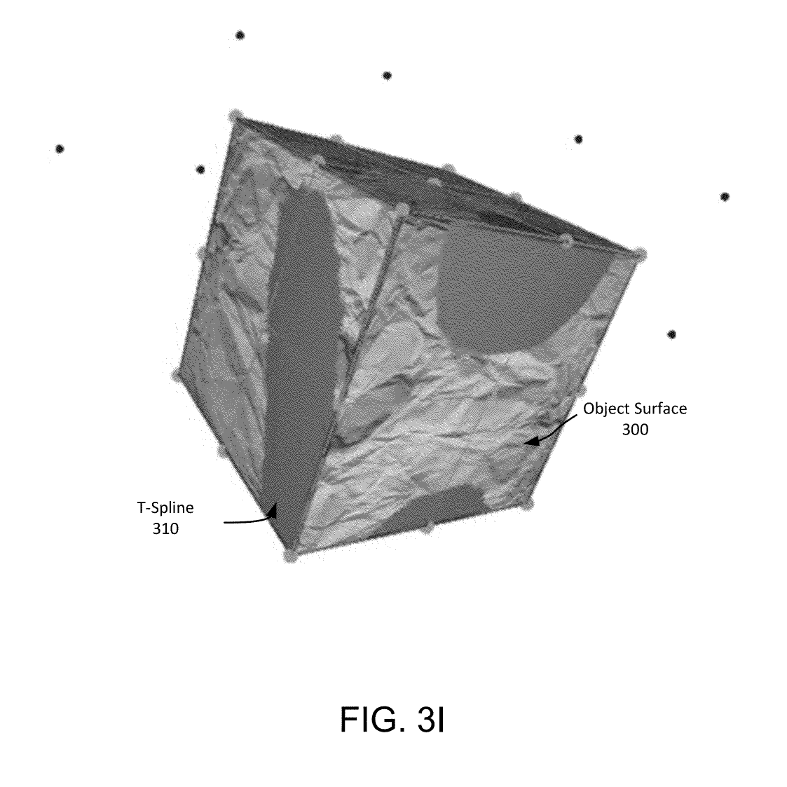

Referring now to FIGS. 3A-3I, FIGS. 3A-3I show an example of an iterative optimization of a T-spline from the initial T-spline 310 shown in FIGS. 3A-3B superimposed onto a textured cube 300. FIG. 3C shows a mesh representation of the initial T-spline 310 superimposed over a mesh representation of the textured cube 300. The photometric error between the T-spline 310 and the 3D object representation 300 is visible in each of these images as differences between the surface defined by the T-spline and the surface of the textured cube 300.

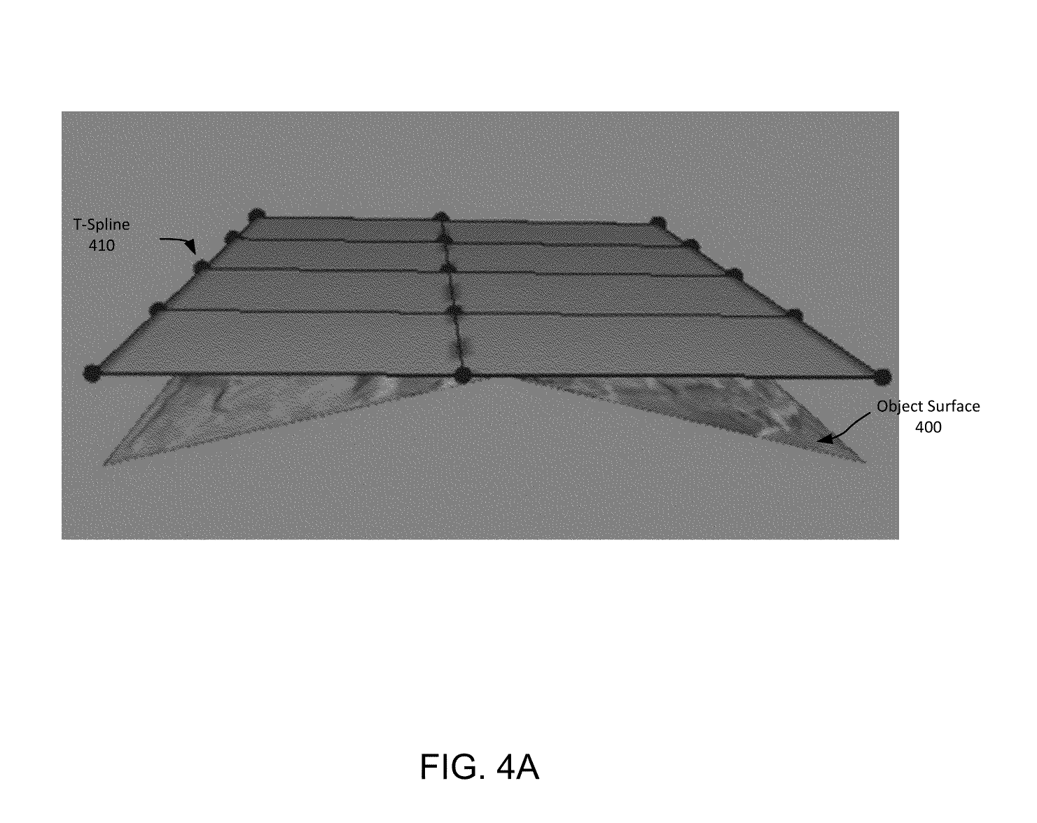

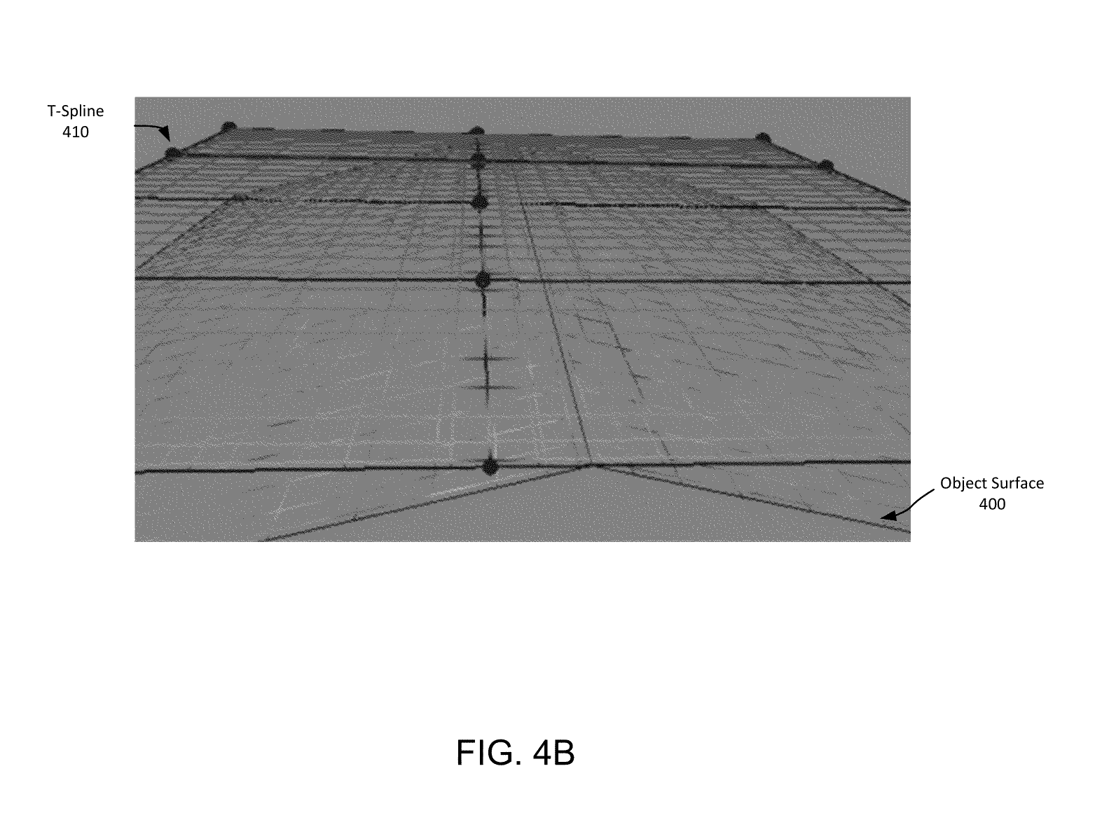

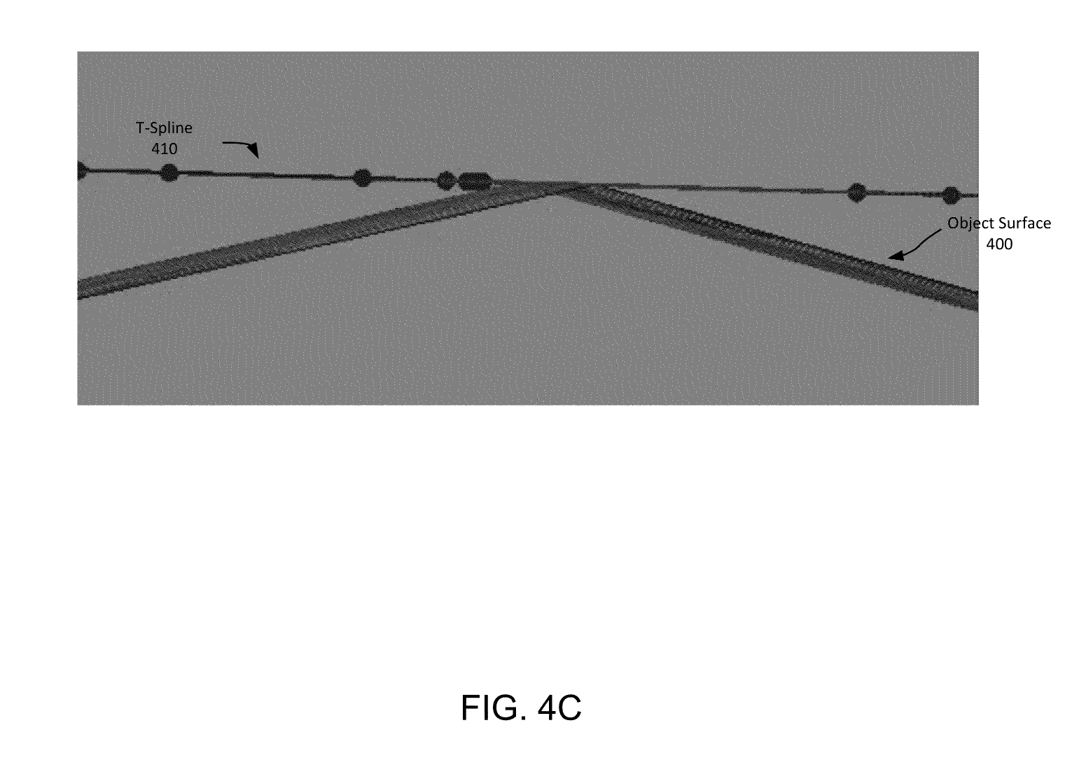

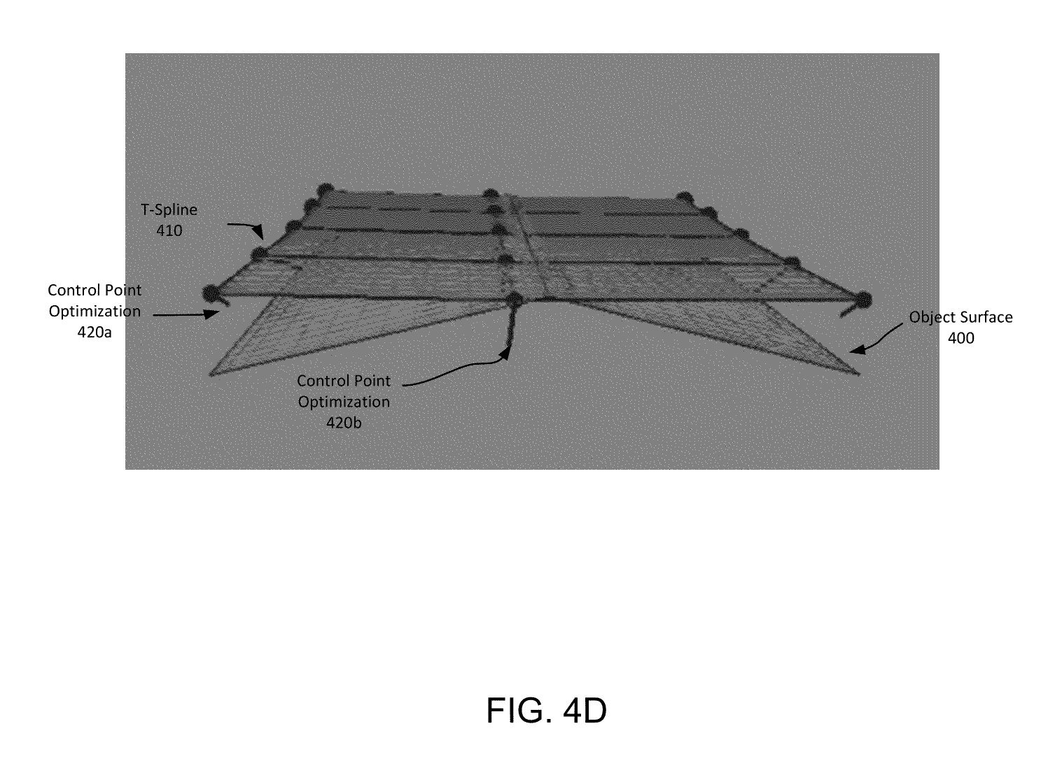

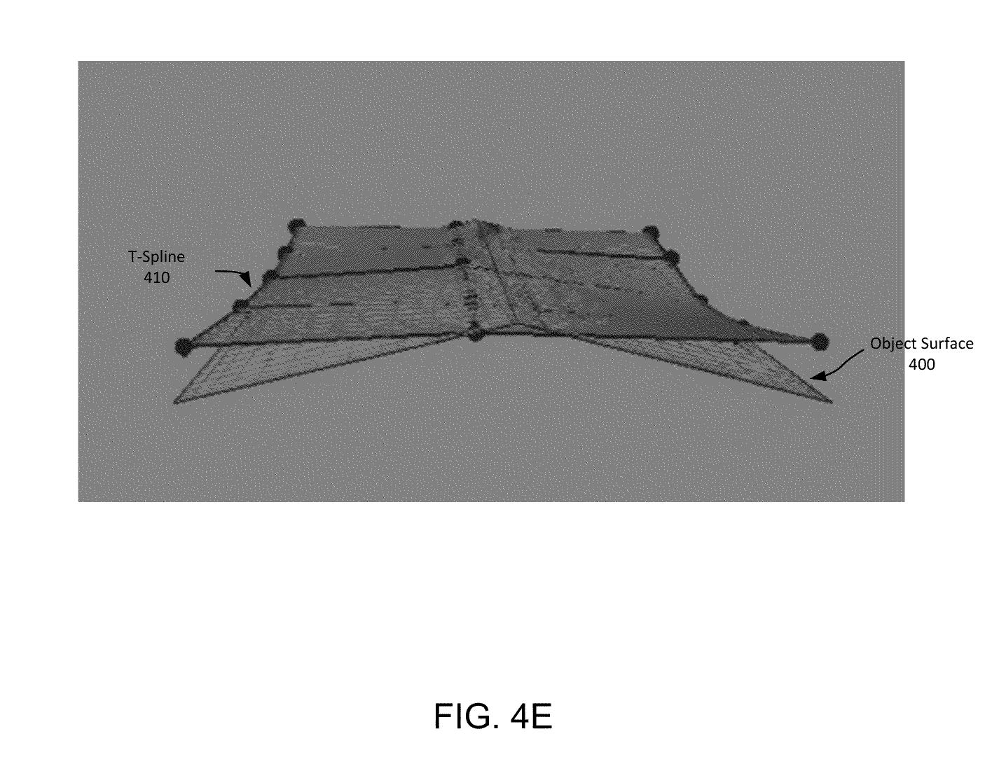

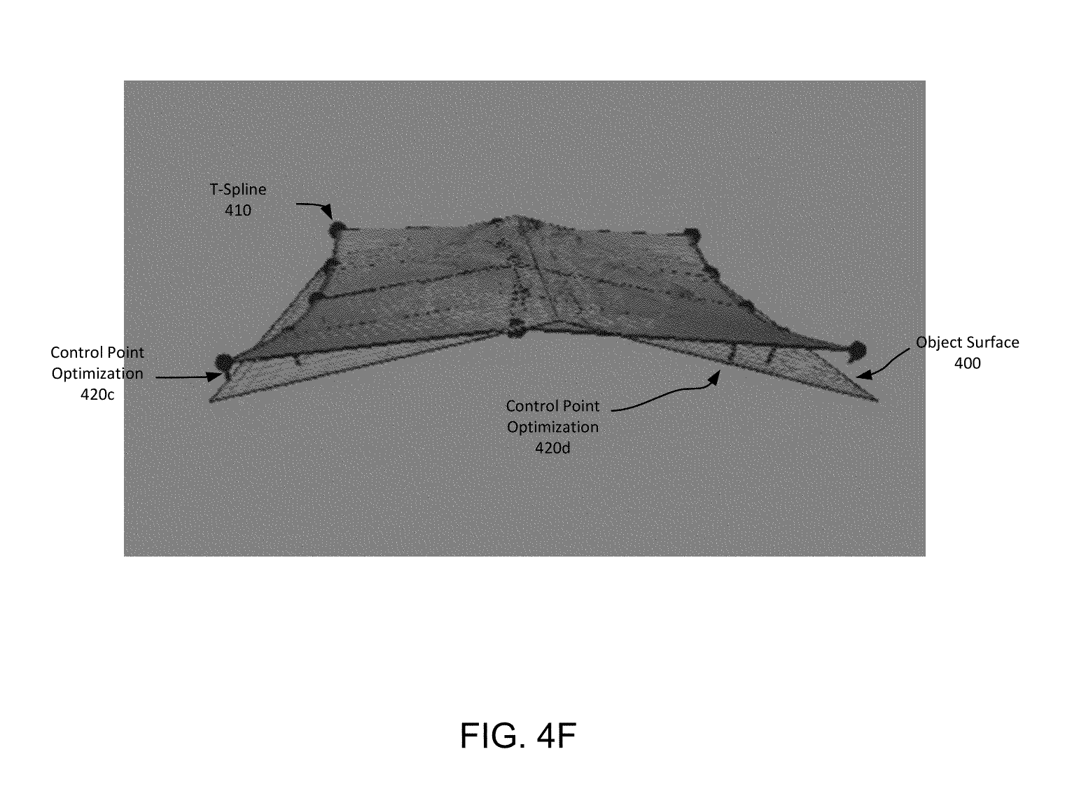

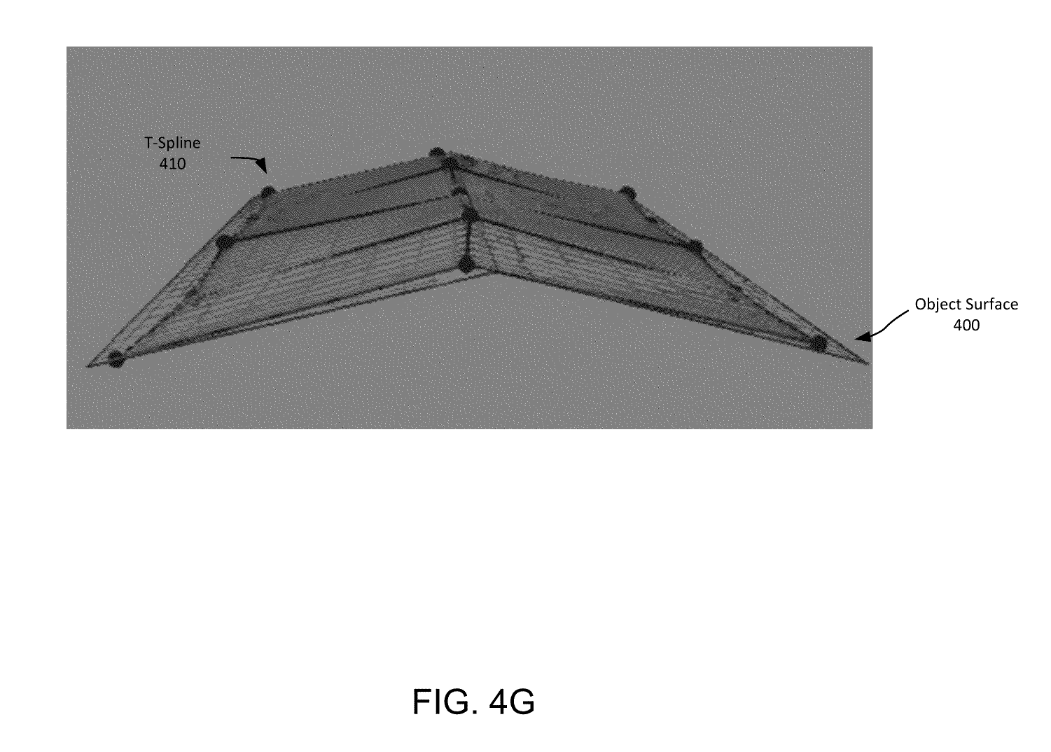

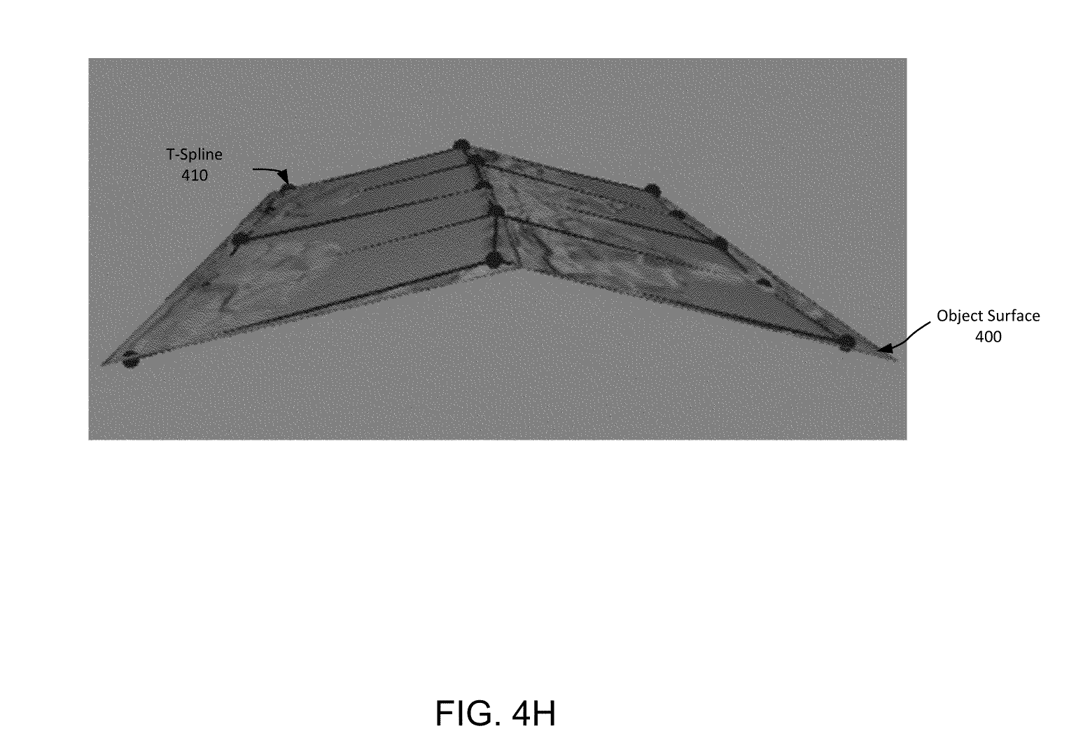

Referring now to FIGS. 4A-4H, FIGS. 4A-H show another example of an iterative optimization of a T-spline from the initial T-spline 410 shown in FIG. 4A superimposed on a textured surface 400. FIGS. 4B-4C show a mesh representation of the initial T-spline 410 superimposed over a mesh representation of the textured surface 400. The photometric error between the T-spline and the 3D object representation is visible in each of these images as differences between the surface defined by the T-spline and the surface of the textured surface 400.

In some examples, other methods may be used than comparing intensities or colors of individual pixels. In one example, a patch of a certain size (typically fixed) around corresponding pixels in images taken from different perspectives may be used with normalized cross-correlation to measure photometric error. Also, the type of normalization used may vary in different examples. In some examples, this may be a squared normalization. In other examples, Pseudo Huber normalization, robust estimators, and other types of normalization may be used. Additionally, the type of optimization scheme could be replaced, e.g., with gradient descent, conjugate gradient, Newton and Quasi Newton methods, trust region methods, etc.

In this example, the computing device 510 derives the photometric error based on a T-spline patch based on a pair of views of the object, though in some other examples, more than a pair of view of the object may be employed. Ultimately, the computing device 510 seeks to minimize the following equation to find control points to approximate the object surface 160:

$$E ( {b}_{j} ) = {\sum }_{t = 1}^{m} \frac{1}{2} {r}_{i}^{2} ( {b}_{j} )$$

Where r represents the residual vector described as:

rᵢ=I₀ [symbol] π [symbol] g₀(xᵢ)−I₁ [symbol] π [symbol] g₁(xᵢ)

Where I₀: Ω→ [symbol] ₊ and I₁: Ω→I [symbol] ₊, two grayscale images. Here, Ω denotes the image plane by π: [symbol] ³→Ω.

After the photometric error has been determined, the method proceeds to block 242.

At block 242, the computing device 510 determines whether the amount of photometric error between the T-spline 170 and the object surface 160 is acceptable. In this example, one or more thresholds may be set and checked against the photometric error. For example, the total photometric error may be determined based on a volume between the T-spline 170 and the object surface 160, and a user-adjustable threshold may establish a maximum acceptable error volume. In some examples, a threshold may be established for the greatest acceptable photometric error between any point on the T-spline 170 and the object surface 160, and so long as the photometric error at at least one point exceeds the threshold, the method 200 may continue to iteratively refine the T-spline.

In some examples, a threshold may be a static value selected by a user, or may be a variable based on attributes of the scene, object, lighting conditions, complexity, or any other such attribute or combinations of such attributes. The value may be a direct measurement associated with photometric error, or may be a complex function or statistic involving, at least in part, information associated with the determined photometric error. In certain embodiments, a result may be displayed to a user, with the threshold operating as an acceptance from the user based on a visual user analysis of the optimized T-spline. If the user rejects the presented T-spline, the system performs another round of optimization. If the user accepts the presented T-spline, then the process ends, and the presented T-spline is used as the final T-spline

If the photometric error is not acceptable, the method 200 proceeds to block 244, otherwise the method proceeds to block 250.

At block 244, the computing device 510 optimizes the T-spline based on the first photometric error to create an optimized T-spline. For example, the computing device can adjust one or more control points of the T-spline to reduce the photometric error.

To adjust control points of the T-spline in this example, the computing device 510 may move a control point of the T-spline in a direction to cause one or more points on the T-spline to move closer to the object surface 160 to better approximate the object surface 160. In this example, the computing device 510 groups sample points on the T-spline into patches, also referred to as T-spline faces. A residual for a T-spline face may be represented:

$${E}_{f} ( {b}_{j} ) = {\sum }_{i = 1}^{m} {\sum }_{v = 1}^{w} \frac{1}{2} {{r}_{iv} ( {b}_{j} )}^{2}$$

Each T-spline face is assigned to a suitable set of views, v, from which the photometric error is observed. Views may be selected such that a point is visible in at least two images. To do so, it may be possible to render the object model and perform occlusion queries to obtain information, for a particular view, as to which pixels on the object surface are not occluded. To increase efficiency, only certain views with a substantial number of visible pixels may be selected.

Next, the gradient of E is calculated by calculating ∇E=Dr^{T} r, and the Jacobian Dr of the residual

$$\frac{\partial {r}_{i}}{\partial {b}_{j}} = ( \frac{\partial {r}_{i}}{\partial {b}_{j}^{x}} , \frac{\partial {r}_{i}}{\partial {b}_{j}^{y}} , \frac{\partial {r}_{i}}{\partial {b}_{j}^{z}} )$$

Where, for brevity only

$$\frac{\partial {r}_{i}}{\partial {b}_{i}}$$

is shown, and the other two follow analogously:

$$\frac{\partial {r}_{i}}{\partial {b}_{j}^{x}} = {ϕ}_{j} ( {ξ}_{i} , {θ}_{i} ) ( 〈 ∇ {I}_{0} , D π {Dg}_{0} {e}^{x} 〉 - 〈 ∇ {I}_{1} , D π {Dg}_{1} {e}^{x} 〉 )$$

Here, e^{x} is the unit basis vector in the x-direction, and the Jacobian of a rigid motion gεSE( [symbol] ³), g(x)=Rx+t, where RεSO( [symbol] ³) and tε [symbol] ³. The Jacobian of the pinhole projection is evaluated at the point xi transformed to the respective local camera coordinates xᵢ^{0,1}=g_{0,1}(xᵢ):

$$Dπ {\vert}_{{x}_{i}^{0 , 1}} = \frac{1}{{z}_{i}^{0 , 1}} ( \begin{matrix}{f}_{u} & o & - \frac{{f}_{u} {x}_{i}^{0 , 1}}{{z}_{i}^{0 , 1}} \\ o & {f}_{v} & - \frac{{f}_{u} {y}_{i}^{0 , 1}}{{z}_{i}^{0 , 1}}\end{matrix} )$$

Where fᵤ, fᵥ are the focal lengths and (cᵤ, cᵥ) is the principal point, though this expression can be further simplified by substituting the projection π in the last column.

It should be noted that hardware acceleration, such as by employing parallelization on a graphical processing unit (“GPU”) may increase the speed of the computations. However, in some cases, a GPU may not support T-splines. In one such example, the computing device 510 discretizes the T-spline face as a quadrilateral mesh using uniform sampling. The parametric coordinates (ξ, θ) may be stored as texture coordinates which may be accessed by a GPU shader in some aspects. Further, the points xᵢ may be approximated by linear interpolation of the vertices within the GPU.

In the case where multiple views may be used, the residual vector may be redefined as follows:

rᵢ=I₀ [symbol] π [symbol] g₀(xᵢ(bⱼ))−Iᵥ [symbol] π [symbol] gᵥ(xᵢ(bᵢ))

Which, as well as the sum over views and color channels, may be evaluated per pixel using a fragment shader using MIP-mapping. In one such example, only the sum of residuals of the relatively small number of T-spline faces f is evaluated using a conventional general-purpose processor. In some examples, it may be possible to compute the Jacobian Dr using a GPU; however, if the GPU is not employed, it may be possible to estimate a best step direction for the optimization of a control point using the gradient of the residual ∇E=Dr^{T} r.

$$g ( {b}_{j} ) = ∇ E ( {b}_{j} ) = {\sum }_{f} {\sum }_{i = 1}^{m} {\sum }_{v = 1}^{w} \frac{1}{w} {r}_{iv} ( \frac{\partial {r}_{i}}{\partial {b}_{j}^{x}} , \frac{\partial {r}_{i}}{\partial {b}_{j}^{y}} , \frac{\partial {r}_{i}}{\partial {b}_{j}^{z}} )$$

With g(bⱼ)ε [symbol] ³ and where

$$\frac{\partial {r}_{iv}}{\partial {b}_{j}^{x}} = {ϕ}_{j} ( {ξ}_{i} , {θ}_{i} ) ( 〈 ∇ {I}_{0} , D π {Dg}_{0} {e}^{x} 〉 - 〈 ∇ {I}_{1} , D π {Dg}_{1} {e}^{x} 〉 )$$

and the remaining two spatial dimensions are computed analogously. In some examples, T-spline faces may be neglected for which a control point has little or no influence. In one such example, only faces in the neighborhood of a control point are evaluated, while all other residual and gradient with respect to the control point are considered to be 0.

Referring now to FIGS. 3D-3H, FIGS. 3D-3H show iterative optimizations of control points of the initial T-spline 310 shown in FIGS. 3A-C to better approximate the object surface 300. As can be seen in each of FIGS. 3D-3H, control points are optimized by moving them in the indicated direction in each of the control point optimizations 320a-i shown in FIGS. 3D-3H. As can be seen, through each iteration, the T-spline 310 better approximates the object surface 300. FIG. 3I shows the T-spline 310 that has been fully optimized in this example.

Referring now to FIGS. 4D-4F, FIGS. 4D-4F show iterative optimizations of control points of the initial T-spline 410 shown in FIGS. 4A-C to better approximate the object surface 400. As can be seen in each of FIGS. 4D-4F, control points are optimized by moving them in the indicated direction in each of the control point optimizations 420a-d shown in FIGS. 4D-4F. As can be seen, through each iteration, the T-spline 410 better approximates the object surface 400. FIGS. 4G-4H shows the T-spline 410 that has been fully optimized in this example.

In some examples, to optimize the T-spline, in addition to, or instead of, moving one or more control points, the computing device 510 can add control points to the T-spline, or delete control points from the T-spline if the control points have little or no influence, though in some examples this step is optional and in any particular iteration no control points may be added or removed. To do so, the computing device 510 compares points having parameters (ξᵢ, θᵢ) that lie within the domain of the respective T-spline face against a threshold. Those exceeding the threshold may be split into half based on their horizontal and vertical dimension. Control points, however, should be added so as to not disrupt previously the performed optimization. In this example, the computing device 510 employs the T-spline insertion algorithm described in “T-spline Simplification and Local Refinement” by Thomas Sederberg et al, published in the ACM Transactions on Graphics, 23(3):276 (2004).

In some examples, the computing device 510 may adjust one or more parameters associated with one or more control points. For example, control points may include parameters other than position parameters (e.g., (x, y, z) coordinates) such as a smoothness parameter. In one example, the computing device 610 may adjust a smoothness parameter of a control point to optimize the T-spline. In some examples, the computing device 610 may adjust a smoothness parameter associated with a control point even if the control point is not otherwise adjusted during an iteration.

After completing the processing at block 244, the method 200 returns to block 240 to determine the photometric error based on the optimized T-spline.

At block 250, the computing device 510 outputs the optimized T-spline. The computing device 510 may output the T-spline by storing it to a memory, displaying it on a display device, transmitting it to a remote server computer or device for remote storage or display, or any other suitable output. After the optimized T-spline has been output, the method 200 completes.

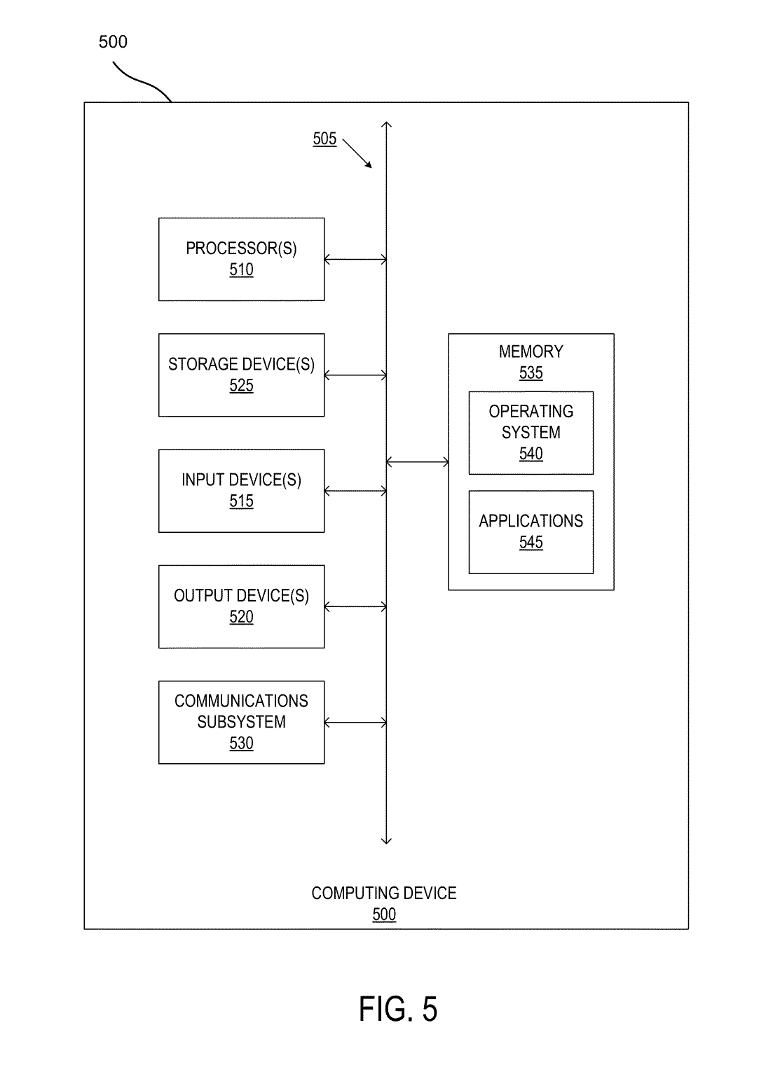

Referring now to FIG. 5, FIG. 5 shows one example of a computing device 510 for photometric optimization with T-splines. The computing device 510, in this example, includes one or more processors 511, one or more storage device 525, one or more input device 515, one or more output device 520, a communications subsystem 530, and memory 535, all of which are in communication with each other via one or more communications buses 505. The memory 535 is configured to store program code for execution by one or more of the processors 510, such as an operating system 540 and one or more applications 545. For example, the memory 535 may store a software application for photometric optimization with T-splines according to this disclosure.

FIG. 6 shows a network that may be used in conjunction with various examples for photometric optimization with T-splines, where computing device 110 may be coupled to portions of the network shown in FIG. 6 or may use resources of such a network to perform processing as part of an implementation where portions of the method of FIG. 2 may be implemented using networked resources. In one example, one or more devices, such as computing device 110, are connected to the network 610. The computing device 110 is configured to access a 3D representation of an object from one or more data stores, such as databases 620a-b. For example, instead of capturing images of an object, the computing device may be provided or may access two or more images of an object from different perspective points, such as from a computer-readable medium or from a database. In some examples, devices may be configured to access the Internet to obtain a 3D object representation, or to store an optimized T-spline.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

What is claimed is:

1. A method of optimizing T-splines using photometric error comprising:
capturing a plurality of images of a scene, wherein each of the plurality of images of the scene captures a different perspective of a portion of an object;
establishing a three-dimensional (“3D”) model of the object using at least some of the plurality of images of the scene;
initializing a T-spline based at least in part on the 3D model;
determining a first photometric error associated with the 3D model and the T-spline; and
optimizing the T-spline based on the first photometric error to create an optimized T-spline.

2. The method of claim 1, wherein determining the first photometric error comprises:
selecting a point on the T-spline,
determining a first pixel in a first image of the plurality of images, the first pixel corresponding to the selected point on the T-spline,
determining a second pixel in a second image of the plurality of images, the second pixel corresponding to the selected point on the T-spline, and
determining a difference in color intensities between the first and second pixels.

3. The method of claim 1, wherein the plurality of images includes a first image of the object captured from a first perspective and a second image of the object captured from a second perspective; and
wherein the photometric error is associated with a point on the T-spline and is based at least in part on a difference in pixel value between a first corresponding pixel in the first image and a second corresponding pixel in the second image.

4. The method of claim 1, wherein the T-spline comprises a set of control points, and optimizing the T-spline further comprising refining the T-spline by adding one or more control points to the set of control points or removing one or more control points from the set of control points.

5. The method of claim 4, wherein the refining further comprises changing one or more parameters of one or more control points, other than a position of the respective control point, in the set of control points.

6. The method of claim 1 wherein optimizing the T-spline based on the photometric error comprises adjusting positions associated with one or more of a set of control points for the T-spline.

7. The method of claim 1 further comprising:
determining a second photometric error based on the optimized T-spline;
determining that the second photometric error exceeds an error threshold;
optimizing the optimized T-spline to create a second optimized T-spline;
determining a third photometric error for the second optimized T-spline;
determining that the third photometric error satisfies the error threshold; and
responsive to determining that the third photometric error satisfies the error threshold, outputting the second optimized T-spline.

8. The method of claim 1, wherein determining the photometric error function comprises:
projecting points on the T-spline in directions associated with the perspectives of the plurality of images;
for each projected point on the T-spline, determining a set of color or intensity values of pixels corresponding to the respective projected point on the T-spline in at least some of the plurality of images; and
for each set of color or intensity values, determining a photometric error based on a difference in the color or intensity values of the set of color or intensity values.

9. A system for optimizing T-splines using photometric error comprising:
a non-transitory computer-readable medium; and
a processor in communication with the non-transitory computer-readable medium and configured to execute program code stored in the non-transitory computer-readable medium, the processor configured by the program code to:
capture a plurality of images of a scene, wherein each of the plurality of images of the scene captures a different perspective of a portion of an object;
establish a three-dimensional (“3D”) model of the object using at least some of the plurality of images of the scene;
initialize a T-spline based at least in part on the 3D model;
determine a first photometric error associated with the 3D model and the T-spline; and
optimize the T-spline based on the first photometric error to create an optimized T-spline.

10. The system of claim 9, wherein the processor is further configured to:
select a point on the T-spline,
determine a first pixel in a first image of the plurality of images, the first pixel corresponding to the selected point on the T-spline,
determine a second pixel in a second image of the plurality of images, the second pixel corresponding to the selected point on the T-spline, and
determine a difference between the first and second pixels to determine the first photometric error.

11. The system of claim 9, wherein the plurality of images includes a first image of the object captured from a first perspective and a second image of the object captured from a second perspective; and
wherein the photometric error is associated with a point on the T-spline and is based at least in part on a difference in pixel value between a first corresponding pixel in the first image and a second corresponding pixel in the second image.

12. The system of claim 9, wherein the T-spline comprises a set of control points, and wherein the processor is further configured to add one or more control points to the set of control points or remove one or more control points from the set of control points to refine the T-spline.

13. The system of claim 10, wherein the processor is further configured to change one or more parameters of one or more control points in a set of control points for the T-spline, other than a position of the respective control point, in the set of control points to refine the T-spline.

14. The system of claim 9, wherein the processor is further configured to adjust positions associated with one or more of a set of control points for the T-spline to optimize the T-spline based on the first photometric error function.

15. The system of claim 9, wherein the processor is further configured to:
determine a second photometric error based on the optimized T-spline;
determine that the second photometric error exceeds an error threshold;
optimize the optimized T-spline to create a second optimized T-spline;
determine a third photometric error for the second optimized T-spline;
determine that the third photometric error satisfies the error threshold; and
responsive to a determination that the third photometric error satisfies the error threshold, output the second optimized T-spline.

16. The system of claim 9, wherein the processor is further configured to:
project points on the T-spline in directions associated with the perspectives of the plurality of images;
for each projected point on the T-spline, determine a set of color or intensity values of pixels corresponding to the respective projected point on the T-spline in each of the plurality of images; and
for each set of color or intensity values, determine a photometric error based on a difference in the color or intensity values of the set of color or intensity values to determine the first photometric error function.

17. A non-transitory computer readable medium comprising program code for causing a processor to execute a method for using T-splines for photometric optimization, the program code comprising:
program code for capturing a plurality of images of a scene, wherein each of the plurality of images of the scene captures a different perspective of a portion of an object;
program code for establishing a three-dimensional (“3D”) model of the object using at least some of the plurality of images of the scene;
program code for initializing a T-spline based at least in part on the 3D model;
program code for determining a first photometric error associated with the 3D model and the T-spline; and
program code for optimizing the T-spline based on the first photometric error to create an optimized T-spline.

18. The non-transitory computer readable medium of claim 17, wherein the program code for determining a first photometric error comprises:
program code for selecting a point on the T-spline,
program code for determining a first pixel in a first image, the first pixel corresponding to the selected point on the T-spline,
program code for determining a second pixel in a second image, the second pixel corresponding to the selected point on the T-spline, and
program code for determining a difference in color intensities between the first and second pixels.

19. The non-transitory computer readable medium of claim 17, wherein the plurality of images includes a first image of the object captured from a first perspective and a second image of the object captured from a second perspective; and
wherein the photometric error is associated with a point on the T-spline and is based at least in part on a difference in pixel value between a first corresponding pixel in the first image and a second corresponding pixel in the second image.

20. The non-transitory computer readable medium of claim 17, wherein the T-spline comprises a set of control points, and further comprising refining the T-spline by adding one or more control points to the set of control points or removing one or more control points from the set of control points.
